(19) United States
(12) Patent Application Publication
(10) Pub. No.: US 2026/0195599 A1
(43) Pub. Date: Jul. 9, 2026

(54) AUTOMAED CREATION OF END-TO-END MACHINE LEARNING PIPELINE

(71) Applicant: International Business Machines Corporation, Armonk, NY (US)

(72) Inventors: Ashlesha Akella, Bangalore (IN); Nitin Gupta, Guragon (IN); Shashank Mujumdar, Guragon (IN); Hima Patel, Bangalore (IN)

(21) Appl. No.: 19/008,781

(22) Filed: Jan. 3, 2025

(51) Int. Cl. G06N 3/0895; G06F 9/451; G06N 5/022

(52) U.S. Cl. CPC G06N 3/0895; G06F 9/451; G06N 5/022

(57) ABSTRACT

An example operation includes one or more of determining a predictive task and one or more constraints of the predictive task based on inputs to a graphical user interface of a software application, executing a machine learning model on input data including the predictive task and the one or more constraints to select a LLM from among a plurality of available LLMs for executing the predictive task, additionally executing the machine learning model on the LLM and the input data to determine a plurality of components of the predictive pipeline including the LLM, and instantiating an instance of the predictive pipeline including the plurality of components and the LLM via the software application.

### BACKGROUND

The process of incorporating a foundational model (e.g., a foundational machine learning model, artificial intelligence model, etc.) is typically based on a few key performance indicators (KPIs) such as cost to maintain, training time, model performance/accuracy, and the like. To utilize a foundational model for a specific use case that adheres to such KPIs, a user typically selects the correct foundational model as well as other functions, including pre-training tasks, prompting approaches, fine-tuning approaches, use case specific datasets, and the like.

### SUMMARY

One example embodiment provides a computer-implemented method for generating a predictive pipeline that may include one or more of determining a predictive task and one or more constraints of the predictive task based on inputs to a graphical user interface of a software application, executing a machine learning model on input data including the predictive task and the one or more constraints to select a large language model (LLM) from among a plurality of available LLMs for executing the predictive task, additionally executing the machine learning model on the LLM and the input data to determine a plurality of components of the predictive pipeline including the LLM, and instantiating an instance of the predictive pipeline including the plurality of components and the LLM via the software application.

Another example embodiment provides a computer system for generating a predictive pipeline that may include a processor set, a set of one or more computer-readable storage media, and program instructions, collectively stored in the set of one or more storage media, that cause the processor set to perform computer operations that may include one or more of determining a predictive task and one or more constraints of the predictive task based on inputs to a graphical user interface of a software application, executing a machine learning model on input data including the predictive task and the one or more constraints to select a large language model (LLM) from among a plurality of available LLMs for executing the predictive task, additionally executing the machine learning model on the LLM and the input data to determine a plurality of components of the predictive pipeline including the LLM, and instantiating an instance of the predictive pipeline including the plurality of components and the LLM via the software application.

A further example embodiment provides a computer program product for generating a predictive pipeline that may include a computer-readable storage medium and program instructions stored on the computer-readable storage medium, wherein the program instructions are executable by a computer processor causing the computer processor to perform one or more functions, the program instructions comprising: program instructions to determine a predictive task and one or more constraints of the predictive task based on inputs to a graphical user interface (GUI) of a software application, program instructions to execute a machine learning (ML) model on input data including the predictive task and the one or more constraints to select a large language model (LLM) from among a plurality of available LLMs for executing the predictive task, program instructions to additionally execute the ML model on the LLM and the input data to determine a plurality of components of the predictive pipeline including the LLM, and program instructions to instantiate an instance of the predictive pipeline including the plurality of components and the LLM via the software application.

A set of one or more computer-readable storage media, and program instructions, collectively stored in the set of one or more computer-readable storage media, for causing a processor set to perform computer operations that may include one of more of determining a predictive task and one or more constraints of the predictive task based on inputs to a graphical user interface of a software application, executing a machine learning model on input data including the predictive task and the one or more constraints to select a large language model (LLM) from among a plurality of available LLMs for executing the predictive task, additionally executing the machine learning model on the LLM and the input data to determine a plurality of components of the predictive pipeline including the LLM, and instantiating an instance of the predictive pipeline including the plurality of components and the LLM via the software application.

### BRIEF DESCRIPTION OF THE DRAWINGS

FIG. 1 is a diagram illustrating a computing environment according to an embodiment of the instant solution.

FIG. 2A is a diagram illustrating a process of generating a pipeline for a large language model (LLM) using machine learning according to an embodiment of the instant solution.

FIG. 2B is a diagram illustrating a process of training a machine learning model according to an embodiment of the instant solution.

FIG. 2C is a diagram illustrating a process of instantiating a pipeline according to an embodiment of the instant solution.

FIG. 3A is a diagram illustrating a process of selecting a LLM for a predictive pipeline according to an embodiment of the instant solution.

FIG. 3B is a diagram illustrating a process of selecting a next component for the predictive pipeline based on the selected LLM according to an embodiment of the instant solution.

FIG. 3C is a diagram illustrating a process of iteratively selecting additional components for the predictive pipeline according to an embodiment of the instant solution.

FIG. 3D is a diagram illustrating a process of retraining a machine learning model based on a reward function according to an embodiment of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

For enterprises, there are many factors to consider before deciding to utilize a foundational model (FM) to serve a use case. The process of incorporating a foundational model into an enterprise setting can be cumbersome, time-consuming, and costly because multiple steps need to be performed. Enterprises are generally interested in few key performance indicators (KPIs) such as training time, model performance, cost, and the like, which they try to optimize for a given use case. To utilize a foundational model given a use case and the KPIs, it is necessary for an executable pipeline to be generated.

The generation of the pipeline requires choosing multiple components such as selecting the correct foundational model, choosing a pre-training task, choosing prompting approaches, choosing fine-tuning approaches, choosing use-case-specific datasets, choosing a tokenizer, and the like. Manually checking all possible combinations of the different pipeline components is practically infeasible. As a result, the optimal components of the pipeline are usually a guess, which can lead to a lack of optimal efficiency.

The example embodiments are directed to a system that can overcome the above-mentioned drawbacks by automatically recommending an end-to-end pipeline for a foundational model based on a use case and based on required KPIs. The system can also dynamically modify the pipeline to adapt to user-specified steps in the pipeline. The system can automatically recommend the various components for the pipeline to make the foundational model ready for the given use case and specified KPIs. The system relies on machine learning which is able to consider all possible combinations of components for the pipeline and automatically identify the correct/most efficient choices of components based on the given task/use case.

The pipeline generation system described herein may be integrated within a software application, a service, or the like, which may be hosted by a host platform such as a cloud platform, a web server, a database, or the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

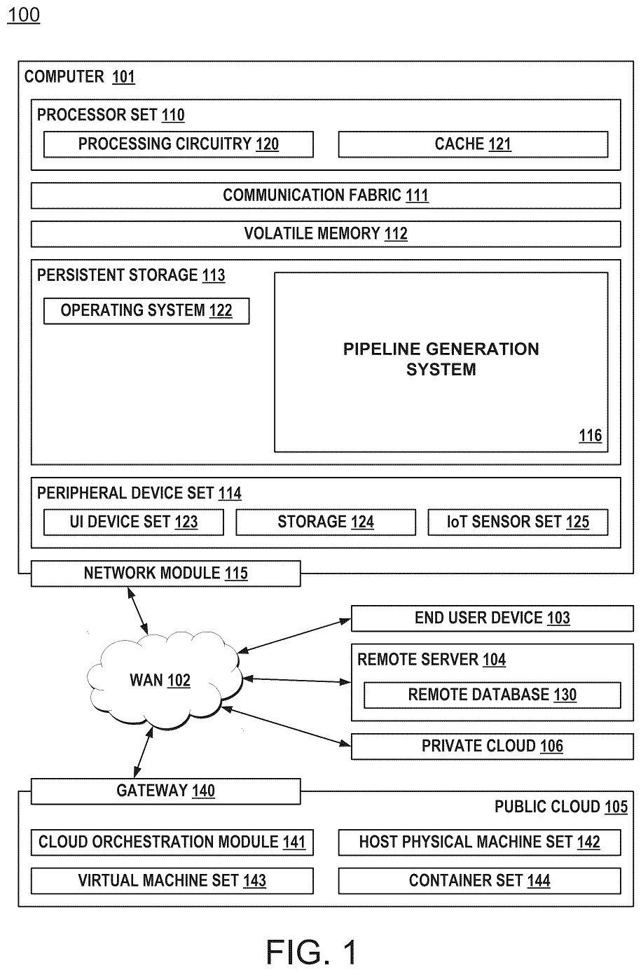

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a pipeline generation system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

CLOUD COMPUTING SERVICES AND/OR MICROSERVICES (not separately shown in FIG. 1) private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system that may be integrated within a software application, and which may be used to train a machine learning model and utilize the trained machine learning model to build a predictive pipeline including recommended choices of components within the pipeline, for example, a type of foundational model (e.g., an LLM), a pre-training task, a tokenizer component, a pre-training component, a knowledge infusion component, a token formatting component, a validation component, and the like.

To automatically build a sequence of recommended choices in an end-to-end pipeline, the system may utilize the cues from historical data, human feedback, and other data constraints (e.g., time, memory, compute cost, model performance, etc.) towards serving an enterprise use case through the foundational model. The system may automatically recommend the optimal steps that maximize the model performance and optimize user-provided constraints with minimal operations. The system may learn from the historical data and reinforce the learning of the machine learning model recommending the optimal components. The system may dynamically update the sequence if user does not follow the initial recommendations.

There are a vast number of choices available for building a predictive pipeline for a machine learning model such as a foundational model. However, selection of most appropriate choices for the data and the orchestrating the right sequence of steps remains ad hoc, with no guarantee that it is optimal. There are several challenges with ad hoc utilization of foundational models. For example, the user making the choices may not have a clear understanding of what foundational model is best for a given use case, the user may not understand the strengths and weaknesses of different choices of pre-training tasks, prompt-tuning approaches, fine-tuning approaches, etc. The various choices can be interdependent and affect the utility of the foundational model which may not be obvious to the user. It is also not possible to try out all choices because doing so is practically infeasible for the user.

The system described herein can automatically identify and recommend the sequence of steps/components for a predictive pipeline to create an end-to-end LLM pipeline to solve a given task based on user-defined/selected constraints. The system can output a recommendation of steps for creating the pipeline. In case the user ignores the recommendation at any point, the system can make dynamic adjustments to the recommend steps based on any additional components or different components requested by a user. Furthermore, the system can incorporate user constraints to drive the pipeline next step recommendations.

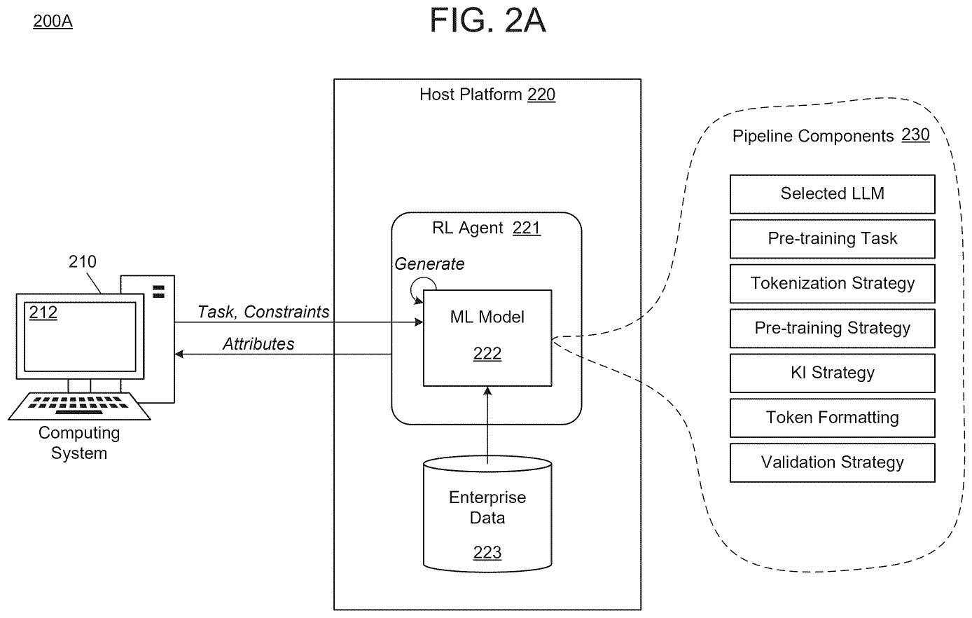

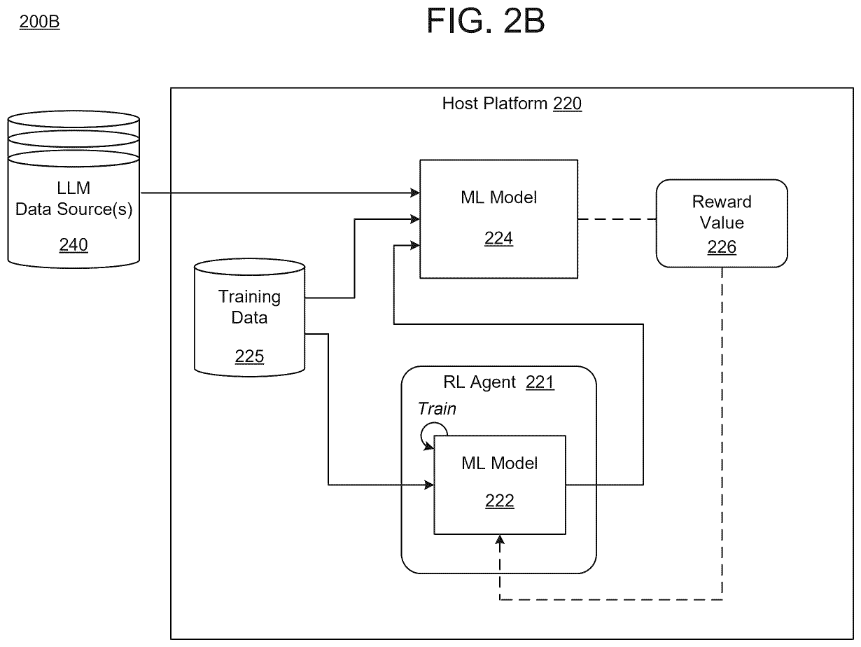

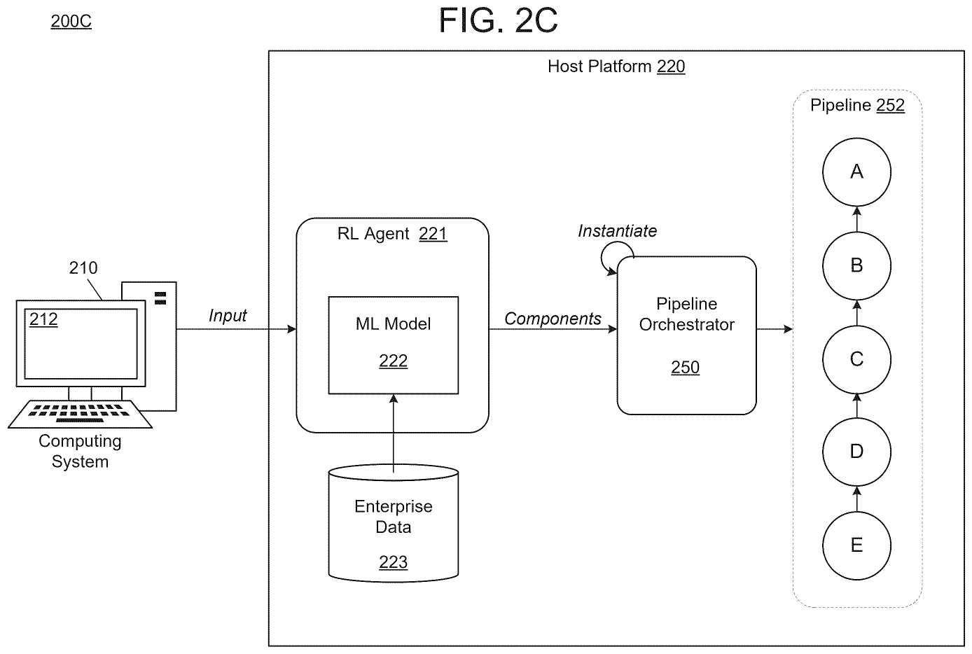

FIG. 2A illustrates a process 200A of generating a pipeline for a large language model (LLM) using machine learning according to an embodiment of the instant solution. Referring to FIG. 2A, a host platform 220 may host a reinforcement learning (RL) agent 221 which includes a machine learning (ML) model 222. The RL agent 221 may be integrated within a software application (not shown) that is hosted by the host platform 220. As an example, the host platform 220 may be a cloud platform, a web server, a distributed system, and the like. The host platform 220 may make the RL agent 221 (e.g., via the software application) available to public systems that can access the host platform 220 over a computer network, such as the Internet, a private network, an on-premises network, or the like.

In the example of FIG. 2A, a user may use a computing system 210 to connect to the host platform 220 and access the RL agent 221. For example, the user may input a web address, IP address, etc. of the software application/RL agent 221 into a browser installed on the computing system 210 which causes the browser to navigate to the RL agent 221. A graphical user interface (GUI) of the RL agent 221 may be output by the RL agent 221 and displayed on a display device 212 of the computing system 210. The GUI may include input mechanisms, buttons, drop-down menus, browsing capabilities, and the like, which the user can use to upload a task to be performed by a machine learning model, such as a foundational model, and constraints/KPIs that are required for the task. These inputs may be transferred from the computing system 210 to the RL agent 221.

The RL agent 221 may also ingest enterprise data 223 from a database and execute the ML model 222 on the task (e.g., predictive task, use case, etc.), the constraints, the enterprise data and the like, and generate pipeline components 230. The process performed by the ML model 222 to generate the pipeline components 230 may be an iterative process. Here, the ML model 222 may be configured to determine an attribute each time it executes, modify the input state to include the predicted attribute, and execute again to predict the next attribute. This process may be repeated until all attributes have been predicted.

Some of the constraints that the user can provide include a type of enterprise data (e.g., tabular, relational database, text, images, audio, etc.), a desired task to be solved (e.g., question answering, data analysis, missing value inference, etc.), allowable maximum computation cost and latency, and the like. The constraints may be entered by the user via the computing system 210, for example, by inputting commands into a GUI displayed on the display device 212 of the computing system 210. The enterprise data, upon which the pipeline is built, may be used to ensure the end-to-end pipeline is within the context of real-world operational data, thereby aligning with enterprise-specific characteristics and constraints. If the user disagrees with any of the pipeline components 230, the user may input commands into the GUI on the display device 212 to request modifications with different components, etc. The RL agent 221 may modify the pipeline components 230 to include any user-requested components.

The RL agent 221 generates a sequence of actions that formulates an optimal pipeline tailored to accommodate given resources and data constraints. The pipeline components 230 serve both training and evaluation purposes. It provides guidance on selecting the most suitable model for the task within KPI constraints, determining the appropriate pre-training requirements, defining a training strategy, and assessing the need for knowledge infusion. Furthermore, the pipeline assists users in deciding whether to train their own model for subsequent evaluation or deployment.

The RL agent 221 is designed to determine the optimal large language model (LLM) to deploy for the task to satisfy the constraints. Using enterprise data, metadata, and KPIs as input, the RL agent 221 employs the ML model 222 to suggest an appropriate LLM. Furthermore, the RL agent 221 modifies the input data to include an identifier for the appropriate LLM to predict the next component in the pipeline (e.g., the pre-training task, etc.) This process may be iteratively repeated until the RL agent 221 has generated recommendations for each of a plurality of pipeline components including the LLM to be used, the pre-training component, the tokenization component, the pre-training strategy, the knowledge infusion component, the token formatting, the validation component, and the like.

FIG. 2B illustrates a process 200B of training the ML model 222 within the RL agent 221 according to an embodiment of the instant solution. According to various embodiments, the ML model 222 learns to select the LLM and the other pipeline components that maximize a reward value output from a reward function. Referring to FIG. 2B, the reward function is implemented as a ML model 224. As an example, the ML model 224 may be a feedforward neural network; however, embodiments are not limited thereto. The ML model 224 may be trained using data about available LLMs which are collected from one or more data sources 240.

According to various embodiments, the system (e.g., a software application (not pictured) on the host platform 220, etc.) may retrieve attributes of the LLMs, such as number of parameters, model size, inference time, computation cost, hardware used, training methods used, time complexity, downstream tasks that can be performed, and the like, for each of the available LLMs from the one or more LLM data sources 240 and build an LLM dataset (e.g., a table) which identifies the available LLMs and their attributes. The ML model 224 may be trained on the LLM data set thereby learning which models perform better for specific tasks, which models perform better under certain constraints, which models reduce cost, latency, etc. and the like.

Next, the RL agent 221 may begin training the ML model 222 to determine optimal model types, and components, for different tasks, constraints, and the like. The training process may use training data 225 which includes training samples such as samples of tasks, constraints associated with the tasks, and the like. Initially, the selection of the LLM by the ML model 222 during training is random. The outputs (e.g., the selected LLM and pipeline components) may be concatenated together and input into the ML model 224. In response, the ML model 224 may generate a reward value 226 which is input to the ML model 222 to train/influence how the ML model 222 makes subsequent predictions.

For example, the ML model 224 may generate a positive reward value when the LLM and components predicted by the ML model 222 align with desired LLM complexity measures learned by the ML model 224 from the LLM dataset. Meanwhile, the ML model 224 may generate a negative reward when the predicted LLM and components by the ML model 222 are misaligned with the optimal measures. Over the course of training, the ML model 222 of the RL agent 221 learns to select the LLM and the pipeline components that maximize rewards, refining its output to recommend the most suitable model.

Similar to learning the optimal LLM selection, the ML model 222 also identifies the most suitable pre-training task. The choice of pre-training task is embedded within the “reward function,” which is represented by the ML model 224 and trained on LLM complexity measures from the LLM dataset. Along with selecting the best LLM and pre-training task, the ML model 222 may also learn to choose the optimal prompting approach. This choice is guided by the reward function which helps the ML model 222 learn to recommend the prompting approach that maximizes performance and efficiency. Likewise, the ML model 222 learns to recommend a pre-training strategy, knowledge infusion strategy, token format, and validation component that maximizes the reward function generated by the ML model 224.

Reinforcement learning (RL) is integral to the system, enabling the RL agent 221 to recommend an end-to-end pipeline for training and validation that aligns with specific KPI constraints. Rather than directly improving the accuracy of the ML model 222, the training focuses on optimizing the entire pipeline selection process. It is trained on LLM complexity measurement data, which is collected from various resources. This data informs the decisions made by the RL agent, allowing it to suggest models, pre-training tasks, and prompting approaches that best meet the requirements of the given task and constraints.

Accumulating LLM complexity data involves gathering detailed information about various large language models (LLMs) from multiple sources, including web repositories, Hugging Face APIs, and other databases. This data includes attributes such as the training methods supported by each LLM, their time complexity, the specific downstream tasks they are pre-trained on, the number of parameters, and model size. With this dataset, the ML model 224, also referred to as a “reward function”, can identify patterns across LLMs, helping the ML model 222 learn to make informed decisions about which model to recommend based on task requirements. For example, the ML model 224 may learn that GPT-3, commonly pre-trained on tasks like question answering and sentiment analysis, may not be the best fit for a specialized task like table summarization. Additionally, the reward function learns to avoid recommending models with large sizes if they do not meet specific KPI constraints (e.g., limited computational resources). Through this process, the ML model 224 generates a reward value to guide the ML model 222 to suggest models that align with both the task requirements and KPI constraints.

FIG. 2C illustrates a process 200C of instantiating a pipeline 252 according to an embodiment of the instant solution. Referring to FIG. 2C, the RL agent 221 may display the predicted components of the pipeline, including the recommended LLM, on a GUI which is displayed on the display device 212 of the computing system 210. Here, a user may input a command to the GUI which confirms/accepts the components of the pipeline, such as the components predicted by the ML model 222, the components modified by the user, and the like.

In response to detect the input confirmation, the RL agent 221 may send an instruction to a pipeline orchestrator 250 with the names of the components and the type of data to be used by the components. In response, the pipeline orchestrator 250 may instantiate/launch the pipeline 252, which includes the components confirmed by the user.

According to various embodiments, the pipeline recommendation process described herein may be performed through an iterative process. During each iteration, the RL agent may determine a component of the pipeline. The process may be repeated iteratively until the RL agent has determined a recommended component for each of a plurality of possible parts of the pipeline.

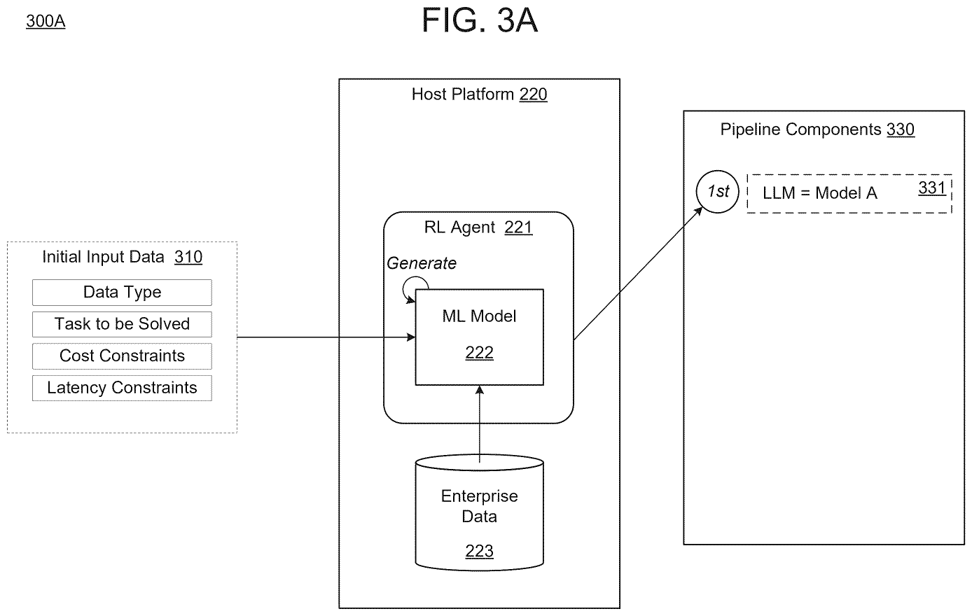

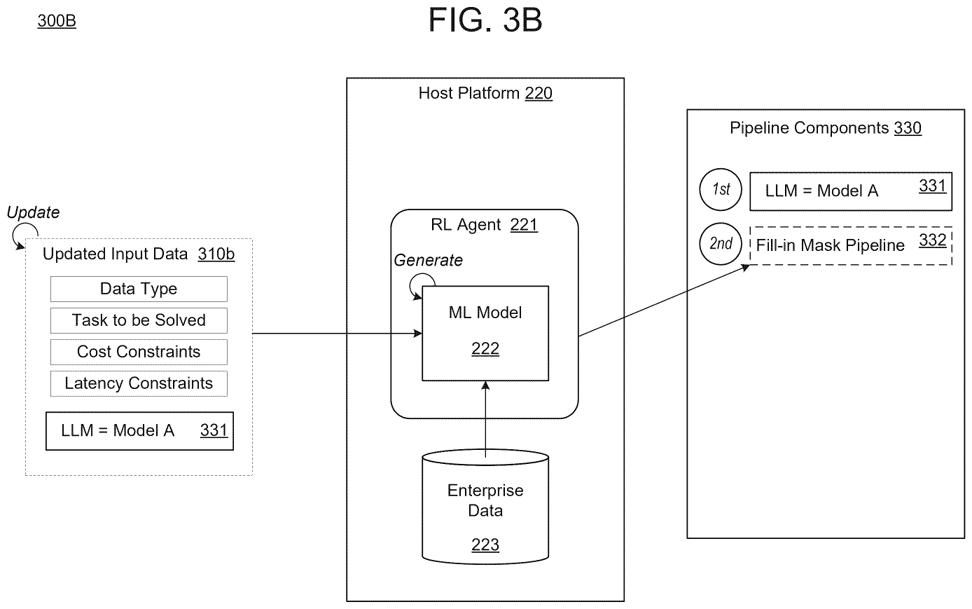

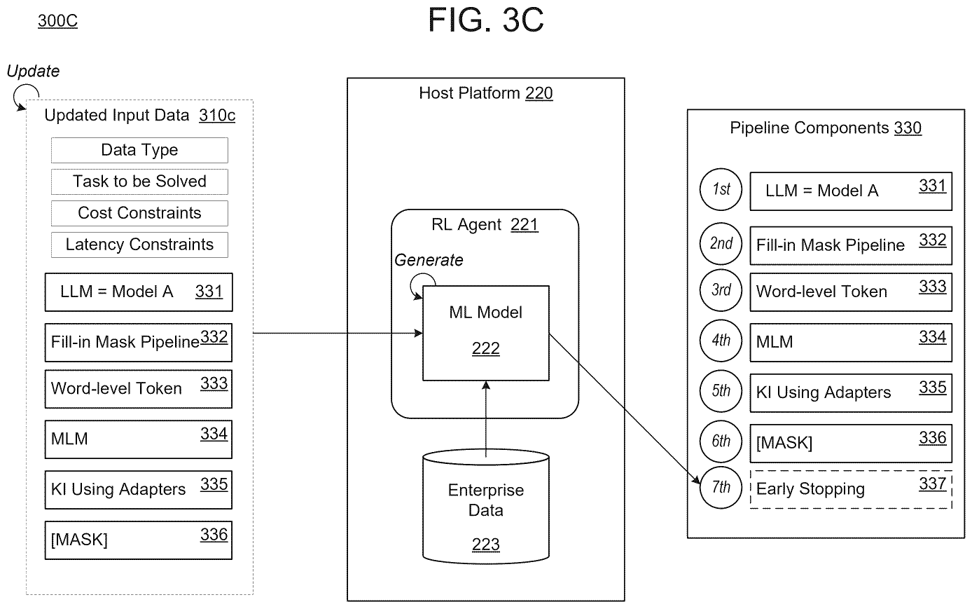

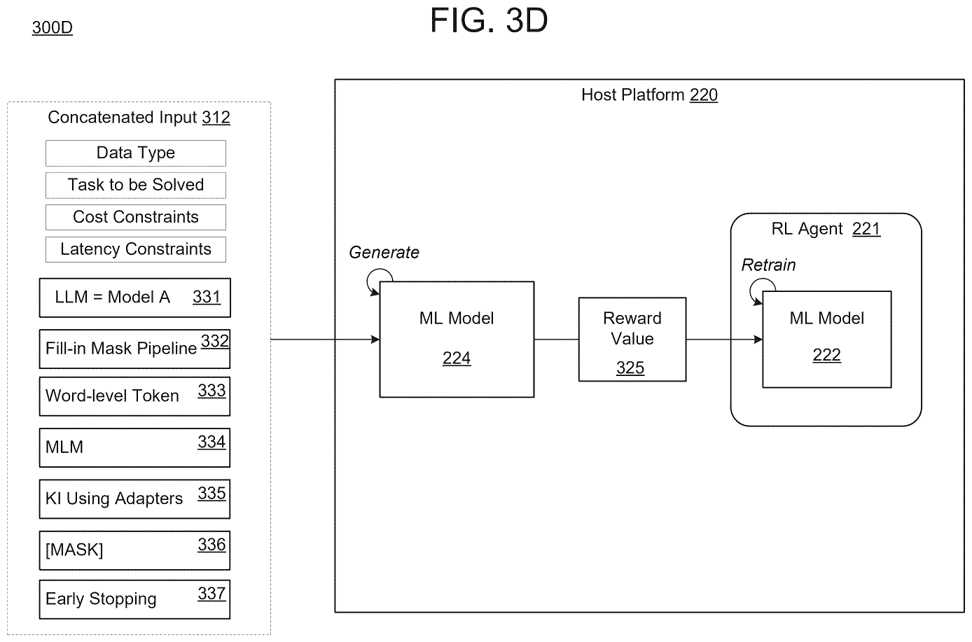

In the examples of FIGS. 3A-3D, an RL agent 221 (e.g., a software application, etc.) performs the task of predicting a plurality of components of a predictive pipeline including an LLM (or other model) to be executed within the predictive pipeline, and other components for pre-training of the LLM, tokenizing input data to the LLM, adding additional knowledge/data to be infused into the LLM, and the like. Here, the RL agent 221 may correspond to the RL agent 221 shown and described in FIGS. 2A-2C.

FIG. 3A illustrates a process 300A of selecting an LLM for a predictive pipeline according to an embodiment of the instant solution. Referring to FIG. 3A, an RL agent 221 is hosted by a host platform 220. In this example, an initial iteration of the RL agent 221 is shown. For example, the user may input data (initial input data 310) which includes a type of data to be used, task(s) to be solved, constraints such as cost and latency, and the like. The initial input data 310 may be input to a ML model 222 of the RL agent 221. In response, the ML model 222 may be trained to predict a recommended LLM and output an identifier of the recommended LLM 331 as part of a plurality of pipeline components 330. Examples of LLMs that can be recommended include GPT-3, GPT-2, BERT, RoBERTa, T5, and the like.

The training process performed for the ML model 222 is shown and described in the example of FIG. 2B. Here, the ML model 222 is trained to identify the LLM that maximizes a reward value generated by a reward function (e.g., the ML model 224 shown in FIG. 3D, etc.) The RL agent 221 may also ingest enterprise data 223, table data, relational data, etc. from a database which can be used to predict/identify the LLM that maximizes the reward value. After the first iteration is performed, the initial input data 310 may be modified to include the identifier of the recommended LLM 331 output by the ML model 222. The initial input data 310 may include additional content not specifically shown in FIG. 3A, for example, enterprise data, metadata, time complexity thresholds, cost thresholds, agent actions (e.g., previous recommendations, etc.).

FIG. 3B illustrates a process 300B of selecting a next component for the predictive pipeline based on the identifier of the recommended LLM 331 according to an embodiment of the instant solution. Referring to FIG. 3B, the RL agent 221 may modify the initial input data 310 to include the identifier of the recommended LLM 331 output by the ML model 222 to generate updated input data 310b. Here, the RL agent 221 may input the updated input data 310b to the ML model 222 which triggers the ML model 222 to predict a recommended pre-training task, for example, fill-in-mask pipeline, next-token prediction pipeline, summarization pipeline, and the like. Here, the output of the ML model 222 is an identifier of the pre-training task 332.

The process of modifying the input data (e.g., the state of the input data) to include the next predicted component may be repeatedly performed until all components are predicted. This process is iterative, with each iteration yielding an additional component recommendation by the ML model 222 and an additional modification to the input data. The ML model 222 knows which component to predict based on the inputs received.

FIG. 3C illustrates a process 300C of iteratively selecting additional components for the predictive pipeline according to an embodiment of the instant solution. Referring to FIG. 3C, the final iteration of the ML model 222/RL agent 221 is shown in this example. Here, the ML model 222 has predicted all but one of the components among the pipeline components 330. In this example, the input data is updated to include the previous six predictions including the identifier of the recommended LLM 331, the identifier of the pre-training task 332, an identifier of a tokenization component 333, an identifier of a pre-training strategy 334, an identifier of knowledge infusion component 335, an identifier of a special token formatting 336, etc. The result is updated input data 310c.

In this example, the updated input data 310c is provided to the ML model 222, which causes the ML model 222 to predict an identifier of a validation component 337. Here, the iterative process may terminate because the components have all been predicted. Furthermore, the RL agent 221 may receive feedback from a second machine learning model and generate model feedback data that includes the feedback and the predicted components. Here, the feedback may include a reward value generated by the second machine learning model. The model feedback data can be used to train/retrain the ML model 222 through a process that is referred to herein as reinforcement learning.

FIG. 3D illustrates a process 300D of retraining the ML model 222 based on a reward function according to an embodiment of the instant solution. Referring to FIG. 3B, the RL agent 221 may concatenate the recommended components into a concatenated input 312 and input the concatenated input 312 into the ML model 224 with a reward function configured to generate a reward value. Here, the ML model 224 may correspond to the ML model 224 shown in the examples of FIG. 2A-2C. The ML model 224 may be trained to identify the best LLM and pipeline components to use for given tasks, constraints, and the like. Here, the ML model 224 may generate a reward value 325 based on the concatenated input 312.

In response, the reward value 325 may be used to retrain the ML model 222. The result is a retrained ML model 222 that can more accurately identify the optimal pipeline components in subsequent predictions.

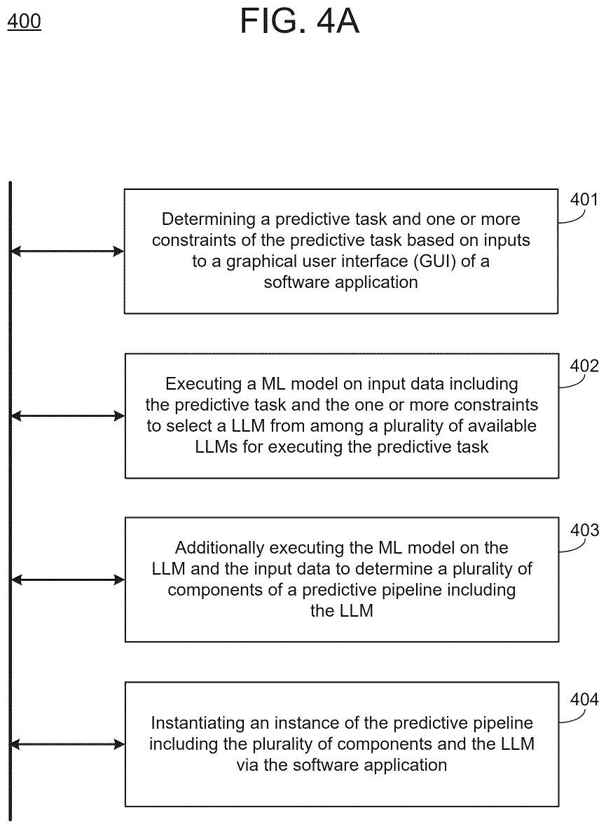

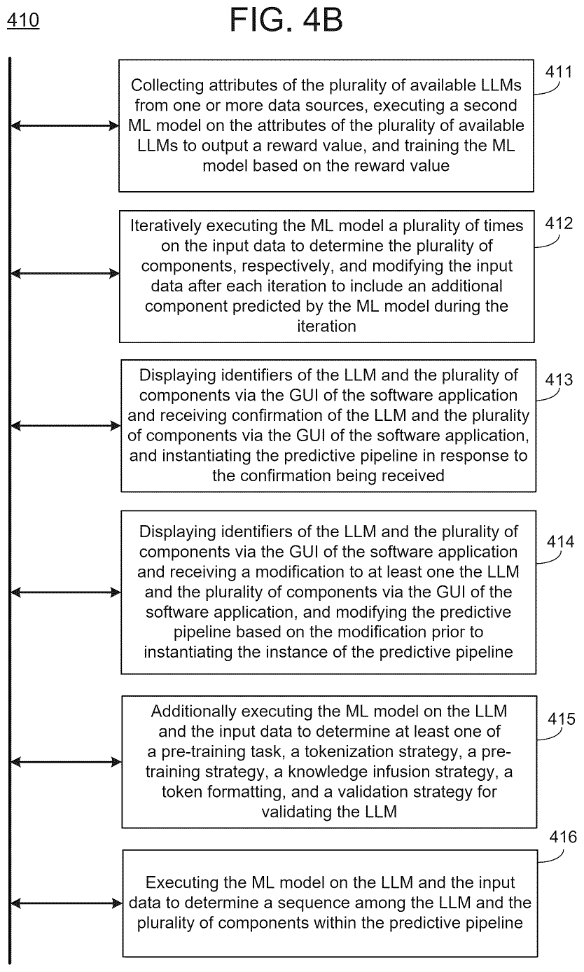

FIG. 4A illustrates a flow diagram of a computer-implemented method 400, according to example embodiments. Referring to FIG. 4A, in 401, the method may include determining a predictive task and one or more constraints of the predictive task based on inputs to a graphical user interface (GUI) of a software application. In 402, the method may include executing a machine learning (ML) model on input data including the predictive task and the one or more constraints to select a large language model (LLM) from among a plurality of available LLMs for executing the predictive task. In 403, the method may include additionally executing the ML model on the LLM and the input data to determine a plurality of components of a predictive pipeline including the LLM. In 404, the method may include instantiating an instance of the predictive pipeline including the plurality of components and the LLM via the software application.

FIG. 4B illustrates a flow diagram of a method 410, according to example embodiments. Referring to FIG. 4B, in 411, the method may include collecting attributes of the plurality of available LLMs from one or more data sources, executing a second ML model on the attributes of the plurality of available LLMs to output a reward value, and training the ML model based on the reward value. In 412, the additionally executing the ML model may include iteratively executing the ML model a plurality of times on the input data to determine the plurality of components, respectively, and modifying the input data after each iteration to include an additional component predicted by the ML model during the iteration.

In 413, the method may include displaying identifiers of the LLM and the plurality of components via the GUI of the software application, receiving confirmation of the LLM and the plurality of components via the GUI of the software application, and instantiating the predictive pipeline in response to the confirmation being received. In 414, the method may include displaying identifiers of the LLM and the plurality of components via the GUI of the software application and receiving a modification to at least one the LLM and the plurality of components via the GUI of the software application, and modifying the predictive pipeline based on the modification prior to instantiating the instance of the predictive pipeline.

In 415, the method may include additionally executing the ML model on the LLM and the input data to determine at least one of a pre-training task, a tokenization strategy, a pre-training strategy, a knowledge infusion strategy, a token formatting, and a validation strategy for validating the LLM. In 416, the additionally executing may include executing the ML model on the LLM and the input data to determine a sequence among the LLM and the plurality of components within the predictive pipeline.

Detailed descriptions of training a machine learning model and executing a machine learning model are further described and depicted herein.

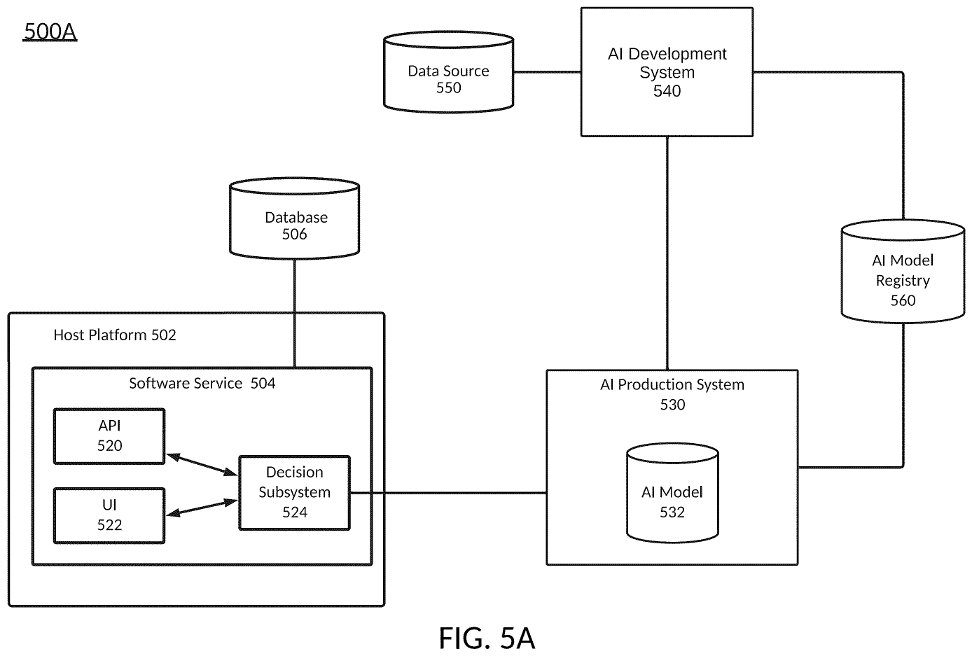

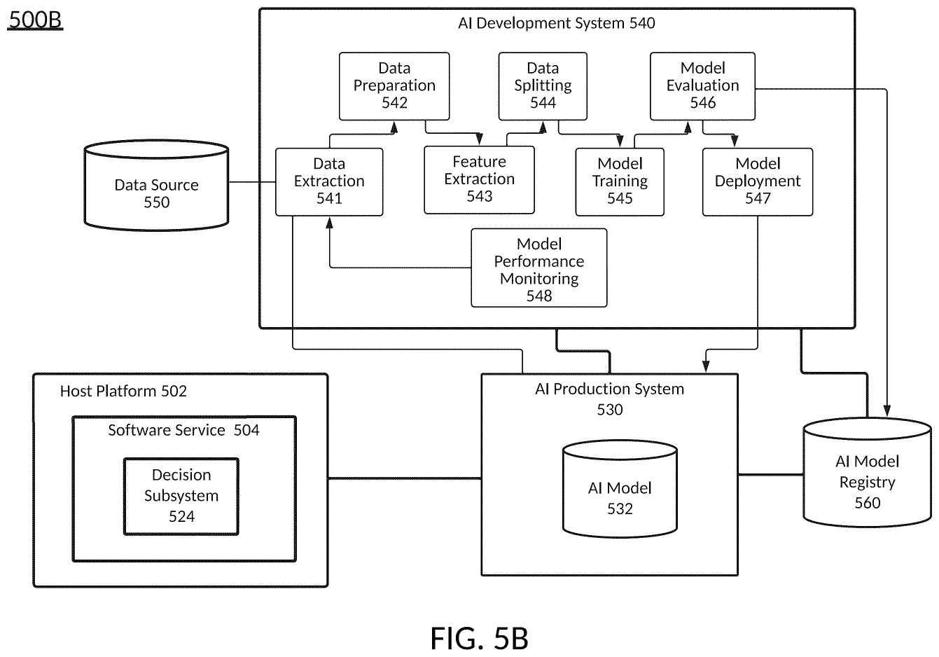

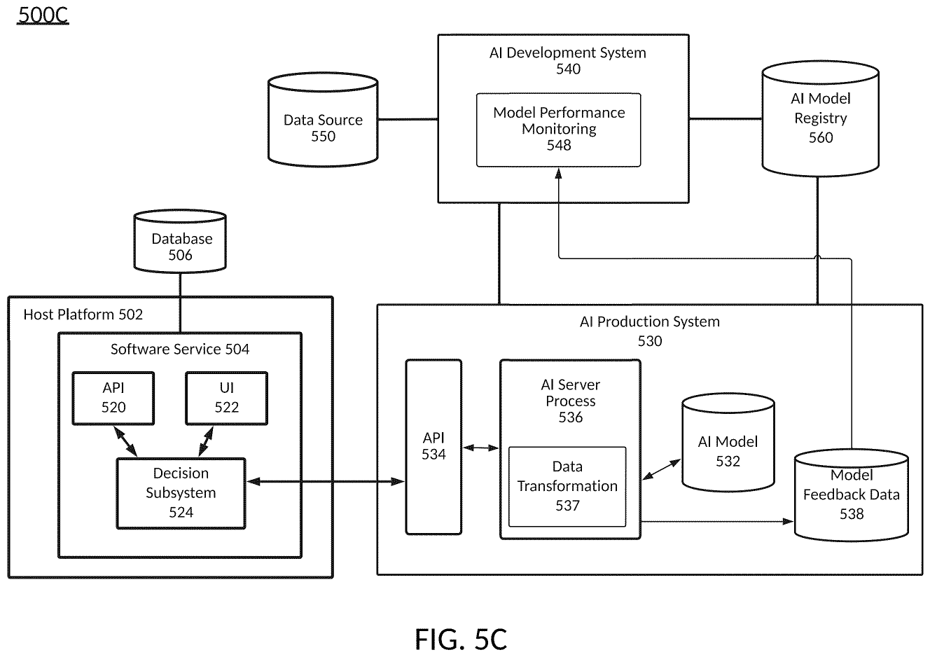

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content—such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or creating entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method for generating a predictive pipeline, the computer-implemented method comprising:
determining a predictive task and one or more constraints of the predictive task based on inputs to a graphical user interface (GUI) of a software application;
executing a machine learning (ML) model on input data including the predictive task and the one or more constraints to select a large language model (LLM) from among a plurality of available LLMs for executing the predictive task;
additionally executing the ML model on the LLM and the input data to determine a plurality of components of the predictive pipeline including the LLM; and
instantiating an instance of the predictive pipeline including the plurality of components and the LLM via the software application.

2. The computer-implemented method of claim 1, further comprising collecting attributes of the plurality of available LLMs from one or more data sources, executing a second ML model on the attributes of the plurality of available LLMs to output a reward value, and training the ML model based on the reward value.

3. The computer-implemented method of claim 1, wherein the additionally executing the ML model comprises iteratively executing the ML model a plurality of times on the input data to determine the plurality of components, respectively, and modifying the input data after each iteration to include an additional component predicted by the ML model during the iteration.

4. The computer-implemented method of claim 1, further comprising displaying identifiers of the LLM and the plurality of components via the GUI of the software application and receiving confirmation of the LLM and the plurality of components via the GUI of the software application, wherein the instantiating comprises instantiating the predictive pipeline in response to the confirmation being received.

5. The computer-implemented method of claim 1, further comprising displaying identifiers of the LLM and the plurality of components via the GUI of the software application and receiving a modification to at least one the LLM and the plurality of components via the GUI of the software application, and modifying the predictive pipeline based on the modification prior to instantiating the instance of the predictive pipeline.

6. The computer-implemented method of claim 1, wherein the additionally executing comprises additionally executing the ML model on the LLM and the input data to determine at least one of a pre-training task, a tokenization strategy, a pre-training strategy, a knowledge infusion strategy, a token formatting, and a validation strategy for validating the LLM.

7. The computer-implemented method of claim 1, wherein the additionally executing comprises executing the ML model on the LLM and the input data to determine a sequence among the LLM and the plurality of components within the predictive pipeline.

8. A computer system for generating a predictive pipeline, the computer system comprising:
a processor set;
a set of one or more computer-readable storage media; and
program instructions, collectively stored in the set of one or more storage media, that cause the processor set to perform computer operations comprising:
determining a predictive task and one or more constraints of the predictive task based on inputs to a graphical user interface (GUI) of a software application;
executing a machine learning (ML) model on input data including the predictive task and the one or more constraints to select a large language model (LLM) from among a plurality of available LLMs for executing the predictive task;
additionally executing the ML model on the LLM and the input data to determine a plurality of components of the predictive pipeline including the LLM; and
instantiating an instance of the predictive pipeline including the plurality of components and the LLM via the software application.

9. The computer system of claim 8, wherein the computer operations further comprise collect attributes of the plurality of available LLMs from one or more data sources, execute a second ML model on the attributes of the plurality of available LLMs to output a reward value, and train the ML model based on the reward value.

10. The computer system of claim 8, wherein the additionally execute the ML model comprises iteratively execute the ML model a plurality of times on the input data to determine the plurality of components, respectively, and modify the input data after each iteration to include an additional component predicted by the ML model during the iteration.

11. The computer system of claim 8, wherein the computer operations further comprise display identifiers of the LLM and the plurality of components via the GUI of the software application and receive confirmation of the LLM and the plurality of components via the GUI of the software application, and instantiate the predictive pipeline in response to the confirmation being received.

12. The computer system of claim 8, wherein the computer operations further comprise display identifiers of the LLM and the plurality of components via the GUI of the software application and receive a modification to at least one the LLM and the plurality of components via the GUI of the software application, and modify the predictive pipeline based on the modification prior to the instance of the predictive pipeline being instantiated.

13. The computer system of claim 8, wherein the additionally execute comprises additionally execute the ML model on the LLM and the input data to determine at least one of a pre-training task, a tokenization strategy, a pre-training strategy, a knowledge infusion strategy, a token formatting, and a validation strategy for validation of the LLM.

14. The computer system of claim 8, wherein the additionally execute comprises execute the ML model on the LLM and the input data to determine a sequence among the LLM and the plurality of components within the predictive pipeline.

15. A computer program product for generating a predictive pipeline, the computer program product comprising:
a computer-readable storage medium; and
program instructions stored on the computer-readable storage medium, wherein the program instructions are executable by a computer processor causing the computer processor to perform one or more functions, the program instructions comprising:
program instructions to determine a predictive task and one or more constraints of the predictive task based on inputs to a graphical user interface (GUI) of a software application;
program instructions to execute a machine learning (ML) model on input data including the predictive task and the one or more constraints to select a large language model (LLM) from among a plurality of available LLMs for executing the predictive task;
program instructions to additionally execute the ML model on the LLM and the input data to determine a plurality of components of the predictive pipeline including the LLM; and
program instructions to instantiate an instance of the predictive pipeline including the plurality of components and the LLM via the software application.

16. The computer program product of claim 15, further comprising program instructions to collect attributes of the plurality of available LLMs from one or more data sources, executing a second ML model on the attributes of the plurality of available LLMs to output a reward value, and training the ML model based on the reward value.

17. The computer program product of claim 15, wherein the program instructions to additionally execute the ML model comprises program instructions to iteratively execute the ML model a plurality of times on the input data to determine the plurality of components, respectively, and modify the input data after each iteration to include an additional component predicted by the ML model during the iteration.

18. The computer program product of claim 15, further comprising program instructions to display identifiers of the LLM and the plurality of components via the GUI of the software application and receive confirmation of the LLM and the plurality of components via the GUI of the software application, and wherein the instantiating comprises instantiating the predictive pipeline in response to the confirmation being received.

19. The computer program product of claim 15, further comprising program instructions to display identifiers of the LLM and the plurality of components via the GUI of the software application and receive a modification to at least one the LLM and the plurality of components via the GUI of the software application, and modify the predictive pipeline based on the modification prior to instantiating the instance of the predictive pipeline.

20. The computer program product of claim 15, wherein the program instructions to additionally execute comprises program instructions to execute the ML model on the LLM and the input data to determine a sequence among the LLM and the plurality of components within the predictive pipeline.
